(19) United States
(12) Patent Application Publication
(10) Pub. No.: US 2023/0228592 A1
(43) Pub. Date: Jul. 20, 2023

(54) System and Method for Updating High-Definition Maps for Autonomous Driving

(71) Applicants: Hyundai Motor Company, Seoul (KR); Kia Corporation, Seoul (KR)

(72) Inventor: Jeung Sik Hong, Seoul (KR)

(21) Appl. No.: 18/077,851

(22) Filed: Dec. 8, 2022

(30) Foreign Application Priority Data
Jan. 14, 2022 (KR) 10-2022-0005803

(51) Int. Cl. G01C 21/00; B60W 60/00

(52) U.S. Cl. CPC G01C 21/3841; G01C 21/3822; B60W 60/0011; B60W 2556/40; G07C 5/008

(57) ABSTRACT

An embodiment system for updating high-definition maps for autonomous driving includes a vehicle electronic device configured to transmit determination result data of whether there is consistency with a high-definition map or analysis result data of a difference from the high-definition map, with respect to positioning data for a current location provided from a plurality of sensors according to a presence or an absence of policy information for a driving section and a server configured to provide the policy information and high-definition map data for the driving section to the vehicle electronic device, to determine whether an update is required based on the data received from the vehicle electronic device, and to update the high-definition map data based on the received positioning data.

### CROSS-REFERENCE TO RELATED APPLICATIONS

This application claims the benefit of Korean Patent Application No. 10-2022-0005803, filed on Jan. 14, 2022, which application is hereby incorporated herein by reference.

### TECHNICAL FIELD

The present invention relates to a system and method for updating high-definition maps for autonomous driving.

### BACKGROUND

In recent years, autonomous driving has been in the spotlight as the latest automobile technology. Autonomous driving means that a vehicle grasps road conditions and travels automatically without a driver controlling a brake, a steering wheel, an accelerator pedal, or the like, which may be a key technology for realization of smart vehicles.

For autonomous driving, it is necessary to have a three-dimensional digital map called a high-definition map (HD map). All terrain features around the road on which vehicles will travel, for example, lanes, stop lines, signs, traffic lights, and guard rails are marked on the high-definition map.

A vehicle to which autonomous driving technology is applied acquires information, from such a high-definition map, about the road and its surroundings where the vehicle is currently traveling. However, the condition of the road and its surroundings may change from time to time due to construction or changes in traffic policies. In order to prevent accidents that may occur due to the use of non-real information by the autonomous vehicle, such changes need to be quickly and accurately reflected in the high-definition map. Accordingly, it may be very important to effectively update the high-definition map.

However, according to the current method of creating the high-definition map, it is not easy to know which location in the area marked on the high-definition map has changed. Moreover, even if the location where the change has occurred is found, an operation of directly visiting that location for measurement thereof and mapping its surroundings has to be performed again. This update method is not effective in terms of time and effort.

### SUMMARY

Accordingly, embodiments of the present invention provide a system and method for updating high-definition maps for autonomous driving that substantially obviate one or more problems due to limitations and disadvantages of the related art.

An embodiment of the present invention provides a system and method for enabling a high-definition map to be efficiently updated with little time and effort.

Embodiments of the present invention are not limited to the above-mentioned embodiment, and other embodiments of the present invention can be clearly understood by those skilled in the art to which the present invention pertains from the following description.

Additional advantages, objects, and features of embodiments of the invention will be set forth in part in the description which follows and in part will become apparent to those having ordinary skill in the art upon examination of the following or may be learned from practice of the invention. The features and other advantages of embodiments of the invention may be realized and attained by the structure particularly pointed out in the written description and claims hereof as well as the appended drawings.

To achieve these features and other advantages and in accordance with the invention, as embodied and broadly described herein, there is provided a system for updating high-definition maps for autonomous driving which includes a vehicle electronic device configured to transmit determination result data of whether there is consistency with a high-definition map or analysis result data of a difference from the high-definition map, with respect to positioning data for a current location provided from a plurality of sensors according to the presence or absence of policy information for a driving section, and a server configured to provide the policy information and high-definition map data for the driving section to the vehicle electronic device, to determine whether an update is required based on the data received from the vehicle electronic device, to transmit revised policy information to a vehicle scheduled to enter the driving section, and to update the high-definition map data based on the received positioning data.

In the system, when there is no policy information for the driving section, the vehicle electronic device may compare the positioning data sensed at a basic cycle with the high-definition map data and determine whether to perform autonomous driving according to the result of comparison.

In the system, when the difference between the positioning data and the high-definition map data is out of an error range, the vehicle electronic device may stop the autonomous driving and transmit, to the server, the result of determination of whether there is consistency with the high-definition map.

In the system, when there is a policy for the driving section, the vehicle electronic device may stop the autonomous driving and analyze the difference between the positioning data for the driving section and the high-definition map data to transmit vehicle speed and difference data at the time of measurement to the server.

In the system, the vehicle electronic device may perform positioning of the driving section according to the cycle requested by the server.

In the system, the vehicle electronic device may compare lanes and presence or absence of curbs or obstacles in the driving section with the high-definition map data through the plurality of sensors and transmit a direction of difference and an amount of difference to the server.

In the system, when the server receives an inconsistency result between the information positioned from the vehicle electronic device and the high-definition map information at a ratio of 80% or more, the server may calculate an optimal positioning cycle for the regulation speed of the driving section and the number of positioning vehicles and transmit policy information for the driving section to an electronic device of a vehicle scheduled to enter the driving section.

In the system, the server may calculate a positioning cycle for positioning data at intervals of up to 20 cm at the regulation speed of the driving section.

In the system, the server may calculate the number of positioning vehicles for a speed section in which the positioning cycle exceeds a predetermined limit.

In the system, the server may calculate positioning policy information to perform positioning by providing different positioning starting points to the electronic device of each positioning vehicle and transmit the calculated positioning policy information to a vehicle scheduled to enter that section.

In the system, when the server receives, from the vehicle electronic device, the analysis result data of difference from the high-definition map, the server may transmit new positioning policy information to an electronic device of a vehicle scheduled to enter the driving section when the difference between the vehicle speed at the time of measurement and the vehicle speed according to the policy is equal to or greater than the error range, or otherwise may transmit the updated high-definition map data when the difference between the vehicle speed at the time of measurement and the vehicle speed according to the policy is within the error range.

In another embodiment of the present invention, there is provided a method of updating high-definition maps for autonomous driving, which includes comparing a positioning result with high-definition map data according to the policy information of a predetermined section in an electronic device of an autonomous vehicle traveling at that section, transmitting comparison result data to a server according to the policy information in the electronic device of the autonomous vehicle, calculating a condition for extracting high-definition map information of that location according to the comparison result data received from the server, and transmitting the information to an electronic device of an autonomous driving vehicle corresponding to the condition for extracting information from the server.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain principles of the invention. In the drawings:

FIG. 1 is an exemplary diagram schematically illustrating a configuration of a system for updating high-definition maps for autonomous driving according to embodiments of the present invention;

FIG. 2 is a control block diagram of the vehicle illustrated in FIG. 1;

FIG. 3 is a control block diagram of the autonomous device illustrated in FIG. 2;

FIG. 4 is a block diagram illustrating a configuration of the object detection device of FIG. 2;

FIG. 5 is a flowchart illustrating an operation performed by an electronic device of an autonomous vehicle;

FIG. 6 is a flowchart illustrating an operation performed by a server that receives, from a vehicle that does not receive policy information, a comparison result indicating that a positioning result is different from high-definition map information; and

FIG. 7 is a flowchart illustrating an operation performed by the server that receives, from a vehicle that receives policy information, a difference from a high-definition map.

### DETAILED DESCRIPTION OF ILLUSTRATIVE EMBODIMENTS

The specific structural and functional descriptions disclosed herein are merely illustrated for the purpose of describing embodiments of the present invention. The present invention may be embodied in different forms, and should not be construed as being limited to the embodiments set forth herein.

Specific embodiments will be described in detail below with reference to the accompanying drawings since the present invention may be subjected to various modifications and have various examples. It should be understood, however, that the present invention is not intended to be limited to the specific embodiments, but the present invention includes all modifications, equivalents or replacements that fall within the spirit and scope of the invention as defined in the following claims.

Terms such as “first” and/or “second” may be used herein to describe various elements of embodiments of the present invention, but these elements should not be construed as being limited by the terms. These terms will be used only for the purpose of differentiating one element from other elements of embodiments of the present invention. For example, without departing from the scope and spirit of the present invention, a first element may be referred to as a second element, and, similarly, a second element may also be referred to as a first element.

It will be understood that when an element is referred to as being “coupled” or “connected” to another element, it can be directly coupled or connected to the other element or intervening elements may also be present. On the other hand, it will be understood that when an element is referred to as being “directly coupled” or “directly connected” to another element, no intervening elements are present. Other expressions for describing relationships between elements, for example, “between” and “immediately between” or “neighboring” and “directly neighboring” may also be interpreted likewise.

The terminology used herein is for the purpose of describing particular embodiments only, and is not intended to limit the present invention. As used herein, the singular forms “a,” “an” and “the” are intended to include the plural forms as well, unless context clearly indicates otherwise. It will be further understood that the terms “comprises/includes” and/or “comprising/including”, when used in the specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms used herein, including technical and scientific terms, have the same meanings as those commonly understood by one of ordinary skill in the art. It will be further understood that terms, such as those defined in commonly used dictionaries, should be interpreted as having a meaning that is consistent with their meaning in the context of the relevant art and embodiments of the present invention, and will not be interpreted in an idealized or overly formal sense unless expressly so defined herein.

Meanwhile, when an embodiment is otherwise implementable, the functions or operations specified in a specific block may occur in a different order from those specified in the flowchart. For example, two consecutive blocks may be performed substantially simultaneously, or the blocks may be performed in reverse according to the function or operation related thereto.

Hereinafter, a system and method for updating high-definition maps for autonomous driving according to embodiments of the present invention will be described with reference to the accompanying drawings.

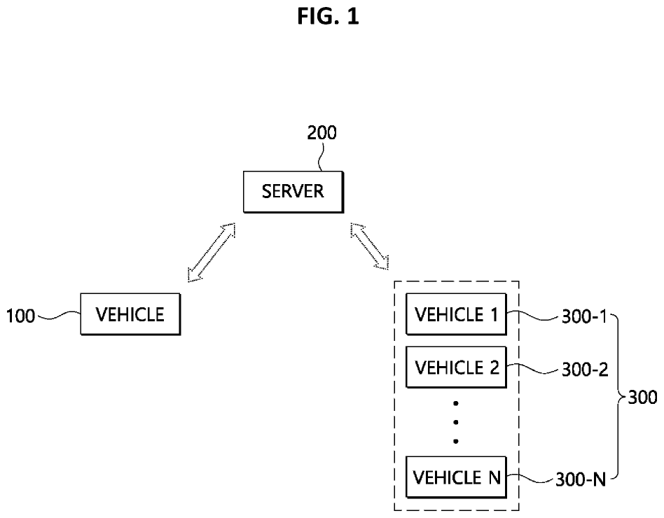

FIG. 1 is an exemplary diagram schematically illustrating a configuration of a system for updating high-definition maps for autonomous driving according to embodiments of the present invention. The system includes an autonomous vehicle 100, a server 200, and a plurality of other vehicles 300.

The autonomous vehicle 100 transmits determination result data of whether there is consistency with a high-definition map or analysis result data of a difference from the high-definition map, with respect to positioning data for a current location provided from a plurality of sensors according to the presence or absence of policy information for a driving section.

The server 200 provides policy information and high-definition map data for a driving section to an electronic device of the autonomous vehicle 100, determines whether an update is required based on the data received from the electronic device of the autonomous vehicle 100, transmits the revised policy information to the autonomous vehicle 100 scheduled to enter the driving section, and updates the high-definition map data based on the received positioning data.

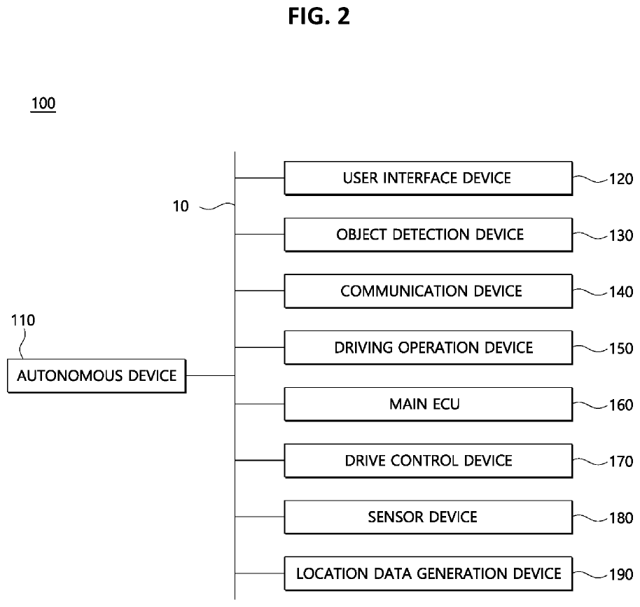

FIG. 2 is a control block diagram of the vehicle of FIG. 1. Referring to FIG. 2, the autonomous vehicle 100 may include an autonomous device 110, a user interface device 120, an object detection device 130, a communication device 140, a driving operation device 150, a main electronic control unit (ECU) 160, a drive control device 170, a sensor device 180, and a location data generation device 190. The object detection device 130, the communication device 140, the driving operation device 150, the main ECU 160, the drive control device 170, the autonomous device 110, the sensor device 180, and the location data generation device 190 may be implemented as electronic devices that each generate electrical signals and exchange electrical signals with each other.

The user interface device 120 is a device for allowing for communication between the autonomous vehicle 100 and a user. The user interface device 120 may receive a user input and provide information generated by the autonomous vehicle 100 to the user. The autonomous vehicle 100 may implement a user interface (UI) or a user experience (UX) through the user interface device 120. The user interface device 120 may include an input unit, an output unit, and a user monitoring unit.

The object detection device 130 may generate information on an object external to the autonomous vehicle 100. The object information may include at least one of information on the presence or absence of an object, object location information, distance information between the autonomous vehicle 100 and the object, and speed information of the vehicle 100 relative to the object. The object detection device 130 may detect an object external to the autonomous vehicle 100.

The communication device 140 may exchange signals with a device located outside the autonomous vehicle 100. The communication device 140 may exchange signals with at least one of an infrastructure (e.g., a server or a broadcasting station), another vehicle, and a terminal. The communication device 140 may include at least one of a transmit antenna, a receive antenna, a radio frequency (RF) circuit capable of implementing various communication protocols, and an RF element to perform communication.

The driving operation device 150 is a device that receives a user input for driving. In a manual mode, the autonomous vehicle 100 may be driven in response to the signal provided by the driving operation device 150. The driving operation device 150 may include a steering input unit (e.g., a steering wheel), an acceleration input unit (e.g., an accelerator pedal), and a brake input unit (e.g., a brake pedal).

The main ECU 160 may control an overall operation of at least one electronic device included in the autonomous vehicle 100.

The drive control device 170 is a device for electrically controlling a variety of vehicle drive devices internal to the autonomous vehicle 100. The drive control device 170 may include a powertrain drive control unit, a chassis drive control unit, a door/window drive control unit, a safety equipment drive control unit, a lamp drive control unit, and an air-conditioning drive control unit. The powertrain drive control unit may include a power source drive controller and a transmission drive controller. The chassis drive control unit may include a steering drive controller, a brake drive controller, and a suspension drive controller.

The drive control device 170 includes at least one electronic control unit (ECU). The drive control device 170 may control the vehicle drive devices in response to the signal received from the autonomous device 110. For example, the drive control device 170 may control a powertrain, a steering device, and a brake in response to the signal received from the autonomous device 110.

The autonomous device 110 may generate a path for autonomous driving based on the acquired data. The autonomous device 110 may generate a driving plan for driving a vehicle along the generated path. The autonomous device 110 may generate a signal for controlling the movement of the vehicle according to the driving plan. The autonomous device 110 may provide the generated signal to the drive control device 170.

The autonomous device 110 may functionally implement at least one advanced driver assistance system (ADAS). The ADAS may implement at least one of adaptive cruise control (ACC), autonomous emergency braking (AEB), forward collision warning (FCW), lane keeping assist (LKA), lane change assist (LCA), target following assist (TFA), blind spot detection (BSD), adaptive high beam control (HBA), auto parking system (APS), pedestrian (PD) collision warning system, traffic sign recognition (TSR), traffic sign assist (TSA), night vision (NV), driver status monitoring (DSM), and traffic jam assist (TJA).

The autonomous device no may allow for switching from an autonomous mode to a manual mode or vice versa. For example, the autonomous device 110 may switch the mode of the autonomous vehicle 100 from the autonomous mode to the manual mode or vice versa in response to the signal received through the user interface device 120.

The sensor device 180 may sense a vehicle state. The sensor device 180 may include at least one of an inertial measurement unit (IMU) sensor, a collision sensor, a wheel sensor, a speed sensor, an inclination sensor, a weight detection sensor, a heading sensor, a position module sensor, a vehicle forward/backward sensor, a battery sensor, a fuel sensor, a tire sensor, a steering sensor, a temperature sensor, a humidity sensor, an ultrasonic sensor, an illuminance sensor, and a pedal position sensor. Here, the IMU sensor may include at least one of an acceleration sensor, a gyro sensor, and a magnetic sensor.

The sensor device 180 may generate vehicle state data in response to the signal generated by at least one sensor. The vehicle state data may be information generated based on the data sensed by various sensors provided inside the vehicle. The sensor device 180 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle inclination data, vehicle forward/backward data, vehicle weight data, battery data, fuel data, tire pressure data, vehicle interior temperature data, vehicle interior humidity data, steering wheel rotation angle data, vehicle exterior illuminance data, accelerator pedal pressure data, brake pedal pressure data, and the like.

The location data generation device 190 may generate location data of the autonomous vehicle 100. The location data generation device 190 may include at least one of a global positioning system (GPS) and a differential global positioning system (DGPS). The location data generation device 190 may generate location data of the autonomous vehicle 100 in response to the signal generated by at least one of the GPS and the DGPS. In an embodiment, the location data generation device 190 may correct the location data through at least one of the IMU sensor of the sensor device 180 and the camera of the object detection device 130. The location data generation device 190 may be referred to as a global navigation satellite system (GNSS).

The autonomous vehicle 100 may include an internal communication system 10. A plurality of electronic devices included in the autonomous vehicle 100 may exchange signals with each other through the internal communication system 10. The signals may each contain data. The internal communication system 10 may use at least one communication protocol (e.g., CAN, LIN, FlexRay, MOST, or Ethernet).

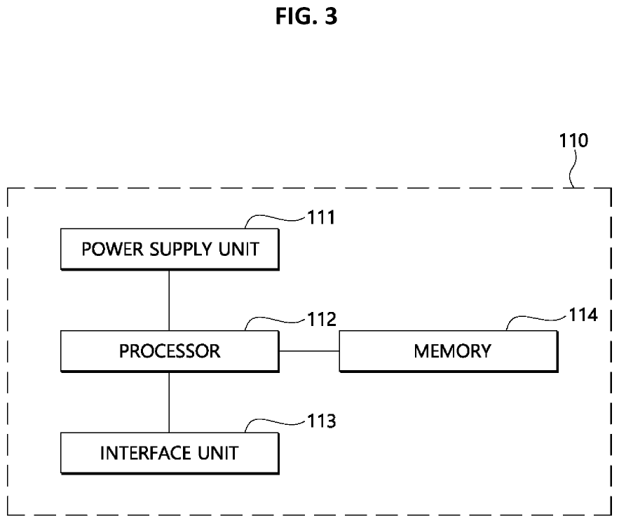

FIG. 3 is a control block diagram of the autonomous device of FIG. 2. Referring to FIG. 3, the autonomous device no may include a power supply unit 111, a processor 112, an interface unit 113, and a memory 114.

The power supply unit 111 may power the autonomous device 110. The power supply unit 111 may be supplied with power from a power source (e.g., a battery) included in the autonomous vehicle 100 and supply power to each unit of the autonomous device 110. The power supply unit 111 may be operated in response to the control signal provided from the main ECU 160. The power supply unit 111 may include a switched-mode power supply (SMPS).

The processor 112 may be electrically connected to the memory 114, the interface unit 113, and the power supply unit 111 for exchange of signals. The processor 112 may be implemented by means of at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and other electrical units for performing functions.

The processor 112 may be driven by power provided from the power supply unit 111. The processor 112 may receive data, process data, generate signals, and provide signals while being powered by the power supply unit 111.

The processor 112 may receive information from other electronic devices within the autonomous vehicle wo through the interface unit 113. The processor 112 may provide control signals to other electronic devices within the autonomous vehicle wo through the interface unit 113.

The interface unit 113 may exchange signals with at least one electronic device included in the autonomous vehicle 100 in a wired or wireless manner. The interface unit 113 may exchange signals with at least one of the object detection device 130, the communication device 140, the driving operation device 150, the main ECU 160, the drive control device 170, the sensor device 180, and the location data generation device 190 in a wired or wireless manner. The interface unit 113 may be configured as at least one of a communication module, a terminal, a pin, a cable, a port, a circuit, an element, and a device.

The memory 114 is electrically connected to the processor 112. The memory 114 may store basic data for units, control data for operation control of units, and input/output data. The memory 114 may store data processed by the processor 112. The memory 114 may be configured as at least one of ROM, RAM, EPROM, a flash drive, and a hard drive in terms of hardware. The memory 114 may store various types of data for the overall operation of the autonomous device no, such as programs for processing or controlling the processor 112. The memory 114 may be formed integrally with the processor 112. In an embodiment, the memory 114 may be classified as a sub-configuration of the processor 112.

The autonomous device no may include at least one printed circuit board (PCB). The memory 114, the interface unit 113, the power supply unit in, and the processor 112 may be electrically connected to the printed circuit board.

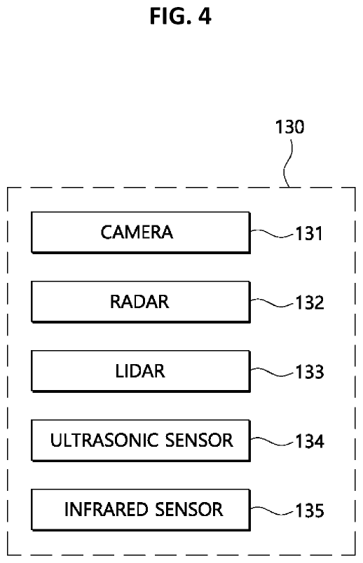

FIG. 4 is a block diagram schematically illustrating a configuration of the object detection device.

The object detection device 130 may include at least one sensor capable of detecting an object external to the autonomous vehicle 100. The object detection device 130 may include at least one of a camera 131, a radar 132, a lidar 133, an ultrasonic sensor 134, and an infrared sensor 135. The object detection device 130 may provide at least one electronic device included in the vehicle with object data generated in response to the signal sensed by the sensor.

The camera 131 may use images to generate information on an object external to the autonomous vehicle 100. The camera 131 may include at least one lens, at least one image sensor, and at least one processor electrically connected to the image sensor to process a received signal and to generate object data in response to the processed signal. The camera 131 may be at least one of a mono camera, a stereo camera, and an around view monitoring (AVM) camera. The camera 131 may use a variety of image processing algorithms to acquire object position information, distance information from an object, or speed information relative to an object. For example, the camera 131 may acquire, from the obtained image, distance information, and relative speed information with respect to an object based on the change in object size over time. For example, the camera 131 may acquire distance information from and relative speed information with respect to an object through a pin hole model, road surface profiling, or the like.

For example, the camera 131 may acquire, from the stereo image obtained by the stereo camera, distance information, and relative speed information with respect to an object based on disparity information.

The camera 131 may be mounted at a position where a field of view (FOV) may be secured in the vehicle to capture an image external to the vehicle. The camera 131 may be disposed adjacent to a front windshield internal to the vehicle to capture an image in front of the vehicle. The camera 131 may be disposed around a front bumper or a radiator grill. The camera 131 may be disposed adjacent to a rear glass internal to the vehicle to capture an image behind the vehicle. The camera 131 may be disposed around a rear bumper, a trunk, or a tailgate. The camera 131 may be disposed adjacent to at least one side window internal to the vehicle to capture an image of the side of the vehicle. Alternatively, the camera 131 may be disposed around a side mirror, a fender, or a door.

The radar 132 may use radio waves to generate information on an object external to the autonomous vehicle 100. The radar 132 may include an electromagnetic wave transmitter, an electromagnetic wave receiver, and at least one processor electrically connected to the electromagnetic wave transmitter and the electromagnetic wave receiver to process a received signal and to generate object data in response to the processed signal. The radar 132 may be implemented in a pulse radar or continuous wave radar manner in view of the principle of radio wave emission. The radar 132 may be implemented in a frequency modulated continuous wave (FMCW) or frequency shift keying (FSK) manner according to the signal waveform of the continuous wave radar manner. The radar 132 may detect an object, a position of the detected object, a distance from the detected object, and a speed relative to the detected object in a time of flight (TOF) manner or in a phase-shift manner using electromagnetic waves as media. The radar may be disposed at an appropriate location external to the vehicle to detect an object in front of, behind, or at the side of the vehicle.

The lidar 133 may use laser light to generate information on an object external to the autonomous vehicle 100. The lidar 133 may include a light transmitter, a light receiver, and at least one processor electrically connected to the light transmitter and the light receiver to process a received signal and to generate object data in response to the processed signal. The lidar 133 may be implemented in a time of flight (TOF) or phase-shift manner. The lidar 133 may be implemented in a driven or non-driven manner. When implemented in a driven manner, the lidar 133 may be rotated by a motor to detect an object around the autonomous vehicle 100. When implemented in a non-driven manner, the lidar 133 may detect an object located in a predetermined range of the vehicle by light steering. The autonomous vehicle 100 may include a plurality of non-driven lidars. The lidar 133 may detect an object, a position of the detected object, a distance from the detected object, and a speed relative to the detected object in a time of flight (TOF) manner or in a phase-shift manner using laser light as media. The lidar 133 may be disposed at an appropriate location external to the vehicle to detect an object in front of, behind, or at the side of the vehicle.

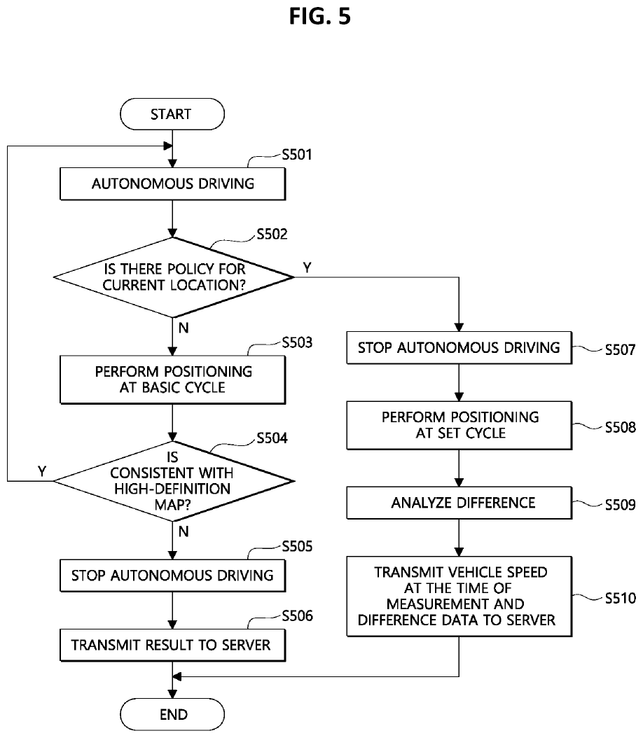

FIG. 5 is a flowchart illustrating an operation performed by the electronic device of the autonomous vehicle.

The autonomous vehicle 100 receives a high-definition map required for a current driving section from the server 200 while starting autonomous driving (S501).

In this case, server policy information for the driving section may be received (S502).

If there is no server policy information for the driving section, the electronic device of the autonomous vehicle uses the object detection device 130 and the sensor device 180 to perform positioning of information external to the vehicle at a basic cycle (S503).

The electronic device checks whether the received external information is consistent with the information of the high-definition map (S504).

If the received external information is not consistent with the information of the high-definition map, the autonomous driving is stopped. That is, when the difference between the positioning data and the high-definition map data is out of an error range, the autonomous driving is stopped (S505).

The electronic device of the autonomous vehicle transmits, to the server, result information (a “difference”) indicating that the high-definition map information is different from the positioning information sensed from the vehicle together with the vehicle location information (S506).

On the other hand, when there is a policy for the driving section, the electronic device of the vehicle stops the autonomous driving (S507). The positioning of information external to the vehicle is performed using the object detection device 130 and the sensor device 180 at a cycle set by the server (S508).

Next, the electronic device calculates the amount of difference from the high-definition map data possessed from the point requested by the server. That is, the positioning of lanes, curbs, presence or absence of obstacles, a direction of difference (vertically and horizontally +, −), and an amount of difference is performed (S509).

After the analysis of the difference is completed, the electronic device of the autonomous vehicle transmits, to the server, the analyzed difference information together with the vehicle speed at the time of measurement (S510).

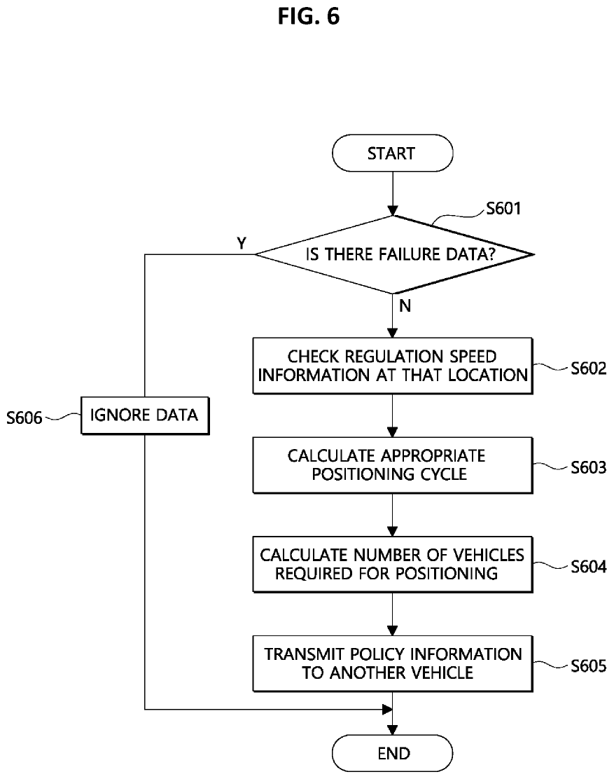

FIG. 6 is a flowchart illustrating an operation performed by the server that receives, from a vehicle that does not receive policy information, a comparison result (a “difference”) indicating that a positioning result is different from high-definition map information. When the server 200 receives the “difference” from the electronic device of the autonomous vehicle 100, the server 200 checks whether the sensor of that vehicle malfunctions. That is, the electronic device of the autonomous vehicle diagnoses failure at every start. The server determines data reliability by checking whether there is connected car service failure diagnosis data (S601). If there is failure data, the server ignores that data (S606).

If there is no failure data, it is determined that the section is a section that needs to be updated when the difference in 80% or more of 50 vehicles is received for that section. In this case, the number and ratio of vehicles is an example, and the present invention is not limited thereto. The server checks regulation speed information at the location of the driving section (S602).

The server calculates an optimal positioning cycle for the regulation speed of the driving section (S603), and calculates the number of positioning vehicles. For example, the server determines an appropriate resolution (e.g., positioning data of up to 20 cm or less) to update the high-definition map based on the regulation speed of that location, and calculates the number of vehicles to secure a resolution of 20 cm or more when exceeding a vehicle positioning limit speed (about 10 ms) for a high-speed section (S604).

The server calculates positioning request policy information to provide different positioning starting points for measurement at intervals of 20 cm, and transmits policy information for the driving section to an electronic device of a vehicle scheduled to enter the driving section (S605).

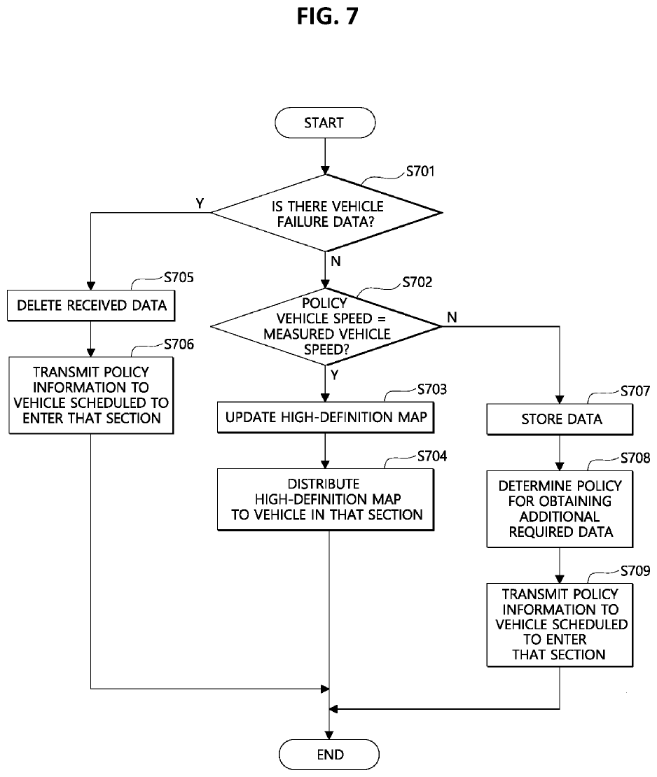

FIG. 7 is a flowchart illustrating an operation performed by the server that receives, from a vehicle that receives policy information, a difference from the high-definition map. When the server receives the positioning result from the vehicle that has received the policy information, for example, the vehicle driving speed at the time of positioning and the difference data from the high-definition map, the server checks whether that vehicle sensor malfunctions (S701). If there is vehicle failure data, the server deletes the received data (S705), and transmits policy information to a vehicle scheduled to enter that section to receive required positioning data (S706).

If there is no vehicle failure data, the server determines whether the vehicle speed at the time of positioning is consistent with the policy vehicle speed at that location (S702).

If the positioning vehicle speed is consistent with the policy vehicle speed, the server updates the high-definition map by comprehensively reflecting the received positioning result on the high-definition map (S703).

The updated high-definition map is distributed to all vehicles intended to enter that section (S704).

If the positioning vehicle speed is not consistent with the policy vehicle speed, the server stores that data (S707) and determines a policy for obtaining additional required data (S708).

The server transmits policy information to a vehicle scheduled to enter that section to receive required positioning data (S709).

As described above, the system and method for updating high-definition maps for autonomous driving according to embodiments of the present invention make it possible to achieve great effects in terms of economic feasibility as well as reliability of updates by allowing the autonomous vehicle equipped with a typical imaging device such as a camera to easily detect the occurrence of changes and update the high-definition map using images acquired through the imaging device and by obtaining a large amount of data collected by numerous autonomous vehicles traveling on the road.

As is apparent from the above description, the system and method for updating high-definition maps for autonomous driving according to embodiments of the present invention make it possible to achieve great effects in terms of economic feasibility as well as reliability of updates by allowing the autonomous vehicle equipped with a typical imaging device such as a camera to easily detect the occurrence of changes and update the high-definition map using images acquired through the imaging device and by obtaining a large amount of data collected by numerous autonomous vehicles traveling on the road.

Although the present invention has been described with respect to the preferred embodiments, it will be understood by those skilled in the art that various modifications and variations can be made without departing from the spirit and scope of the invention as defined in the following claims.

What is claimed is:

1. A system for updating high-definition maps for autonomous driving, the system comprising:
a vehicle electronic device configured to transmit determination result data of whether there is consistency with a high-definition map or analysis result data of a difference from the high-definition map, with respect to positioning data for a current location provided from a plurality of sensors according to the presence or absence of policy information for a driving section; and
a server configured to provide the policy information and high-definition map data for the driving section to the vehicle electronic device, to determine whether an update is required based on the data received from the vehicle electronic device, and to update the high-definition map data based on the positioning data.

2. The system according to claim 1, wherein, in the absence of policy information for the driving section, the vehicle electronic device is configured to compare the positioning data sensed at a basic cycle with the high-definition map data and determine whether to perform autonomous driving according to a result of the comparison.

3. The system according to claim 2, wherein, when the difference between the positioning data and the high-definition map data is out of an error range, the vehicle electronic device is configured to stop the autonomous driving and transmit, to the server, the result of the determination of whether there is consistency with the high-definition map.

4. The system according to claim 1, wherein, in the presence of the policy information for the driving section, the vehicle electronic device is configured to stop the autonomous driving, to analyze the difference between the positioning data of the driving section and the high-definition map data, and to transmit vehicle speed and difference data at the time of measurement to the server.

5. The system according to claim 4, wherein the vehicle electronic device is configured to perform positioning of the driving section according to a cycle requested by the server.

6. The system according to claim 4, wherein the vehicle electronic device is configured to compare lanes and presence or absence of curbs or obstacles in the driving section with the high-definition map data through the plurality of sensors and transmit a direction of the difference and an amount of the difference to the server.

7. The system according to claim 1, wherein, when the server receives an inconsistency result between the positioning data received from the vehicle electronic device and the high-definition map information at a predetermined ratio or more, the server is configured to calculate an optimal positioning cycle for a regulation speed of the driving section and the number of positioning vehicles and transmit the policy information for the driving section to the vehicle electronic device scheduled to enter the driving section.

8. The system according to claim 7, wherein the predetermined ratio is 80% or more.

9. The system according to claim 7, wherein the server is configured to calculate a positioning cycle for positioning data at intervals of up to 20 cm at the regulation speed of the driving section.

10. The system according to claim 9, wherein the server is configured to calculate the number of positioning vehicles for a speed section in which the positioning cycle exceeds a predetermined limit.

11. The system according to claim 10, wherein the server is configured to calculate positioning policy information to perform positioning by providing different positioning starting points to the vehicle electronic device of each positioning vehicle and transmit the calculated positioning policy information to a vehicle scheduled to enter the driving section.

12. The system according to claim 1, wherein, when the server receives, from the vehicle electronic device, the analysis result data of the difference from the high-definition map, the server is configured to:
transmit new positioning policy information to an electronic device of a vehicle scheduled to enter the driving section when a vehicle speed at the time of positioning is not consistent with a policy vehicle speed; or
transmit the updated high-definition map data when the vehicle speed at the time of positioning is consistent with the policy vehicle speed.

13. A method of updating high-definition maps for autonomous driving, the method comprising:
comparing a positioning result with high-definition map data according to policy information of a predetermined driving section in a vehicle electronic device of an autonomous vehicle traveling at the driving section;
transmitting comparison result data to a server according to the policy information in the vehicle electronic device of the autonomous vehicle;
calculating a condition for extracting high-definition map information of that location according to the comparison result data; and
transmitting the information corresponding to the condition for extracting information to a vehicle electronic device of another autonomous driving vehicle.

14. The method according to claim 13, wherein the policy information of the predetermined section is policy information for requesting to transmit a difference between positioning data of the predetermined section and a high-definition map to the server.

15. The method according to claim 14, wherein, when there is a policy for the driving section, the vehicle electronic device stops autonomous driving and analyzes the difference between the positioning data for the driving section and the high-definition map data to transmit vehicle speed and difference data at the time of measurement to the server.

16. The method according to claim 15, wherein the vehicle electronic device performs positioning of the driving section according to a cycle requested by the server.

17. The method according to claim 15, wherein the vehicle electronic device:
compares lanes and presence or absence of curbs or obstacles in the driving section with the high-definition map data through a plurality of sensors; and
transmits a direction of the difference and an amount of the difference to the server.

18. The method according to claim 15, wherein the server receives the comparison result data and then checks whether there is failure data of that vehicle.
